(19) United States
(12) Patent Application Publication
(10) Pub. No.: US 2008/0284240 A1
(43) Pub. Date: Nov. 20, 2008

(54) Brake Control System for Vehicle and Control Method Thereof

(75) Inventor: Bo-Moon Jeong, Gyeongsangbuk-do (KR)

Correspondence Address: LOWE HAUPTMAN HAM & BERNER, LLP, 1700 DIAGONAL ROAD, SUITE 300, ALEXANDRIA, VA, 22314, US

(73) Assignees: Bo-Moon JEONG, Gyeongsangbuk-do (KR); DAEGU MACHINERY INSTITUTE OF COMPONENTS & MATERIALS, Daegu (KR)

(21) Appl. No.: 12/092,815

(22) PCT Filed: Nov. 8, 2006
(86) PCT No.: PCT/KR2006/004660

§ 371 Date: May 6, 2008

(30) Foreign Application Priority Data
Nov. 11, 2005 (KR) 10-2005-0108905
Apr. 11, 2006 (KR) 10-2006-0033433

(51) Int. Cl. B60T 13/138

(52) U.S. Cl. 303/11

(57) ABSTRACT

Provided are a brake control system for a vehicle and a control method thereof. The brake control system includes: a traction valve 30 installed between the master cylinder, the wheel brake 10, and the high pressure accumulator 80, the traction valve 30 including a check valve 31 that is opened only toward the wheel brake 10 and the high pressure accumulator 80 from the master cylinder 20 and an NC solenoid valve 32 that is closed in a normal state OFF in which power is not applied and is opened in a state ON in which power is applied; a pressure sensor 85 installed in the high pressure accumulator 80 and generating a pressure signal by an oil pressure generated in the high pressure accumulator 80; and a shuttle valve 90 installed between the master cylinder 20 and the traction valve 30 and between the low pressure accumulator 40 and the pump 70, the shuttle valve 90 including a check valve 91 that is opened only toward the master cylinder 20 from the low pressure accumulator 40 and an NC solenoid valve 92 that is closed in a normal state OFF in which power is not applied and is opened in a state ON in which power is applied.

### TECHNICAL FIELD

The present invention relates to a brake control system for a vehicle and a control method thereof.

### BACKGROUND ART

Conventional brake control systems for a vehicle have a foot brake used during driving and a side brake for keeping the vehicle parked. Such a brake control system recently employs leading control technology such as an Anti-Lock Brake System (ABS), a Traction Control System (TCS), and an Electronic Stability Program (ESP). At this time, a wheel brake that is operated by the foot brake and has a wheel and a pad, is mounted in four wheels, and a drum brake that is operated by the side brake and has a built-in lining, is installed in two rear wheels separately from the wheel brake.

However, in a conventional brake control system for a vehicle having the above structure, since the drum brake that is operated by the side brake must be employed separately from the wheel brake, consumable components such as a drum for constituting the drum brake, a lining, and cables for closely adhering the lining to an inside of the drum must be used. Thus, there is a problem that the consumable components must be exchanged or periodic after service is needed.

In addition, since the side brake can apply a brake force to only two rear wheels, a parking brake force is small. Thus, when a driver parks a vehicle only using the side brake on a sloped road, the vehicle may be slid, and there are inconveniences that a transmission gear must be placed in a forward or backward state or an object, such as gravel or brick, must be placed under a wheel.

In addition, after parking or stoppage, when the driver continues to drive without releasing a brake state of the side brake through his/her carelessness, a lining that is closely adhered to an inner circumferential surface of the drum may be rapidly worn or serious damage may occur in the brake control system.

In addition, there are always inconveniences that the side brake must be operated so as to release a brake state.

### DISCLOSURE OF INVENTION

### Technical Problem

The present invention provides a brake control system for a vehicle in which a stable brake operation can be performed during driving or stoppage without using a side brake and furthermore, the side brake is not employed so that consumable components for constituting the side brake do not need to be provided or an action for operating the side brake does not need to be taken, and a control method thereof.

The present invention also provides a brake control system for a vehicle in which an Anti-Lock Brake System (ABS), a Traction Control System (TCS), and an Electronic Stability Program (ESP) and an automatic parking function are operated in combination so that more safe driving and brake operations can be performed, and a control method thereof.

### Technical Solution

According to an aspect of the present invention, there is provided a brake control system for a vehicle, the brake control system including: a wheel brake 10 braking four wheels FL, RR, FR, and RL of the vehicle, respectively; a master cylinder 20 generating a brake oil pressure by forcibly transmitting oil according to the operation of a brake pedal 21; a low pressure accumulator 40 in which the oil flowed out from the wheel brake 10 is temporarily stored; a Normal Open (NO) solenoid check valve 50 controlling the amount and flow of the oil transmitted to the wheel brake 10 to control a brake oil pressure applied to the wheel brake 10; a Normal Close (NC) solenoid valve 60 installed between the wheel brake 10 and the low pressure accumulator 40 and controlling the amount and flow of the oil transmitted to the low pressure accumulator 40 from the wheel brake 10 to control a brake oil pressure applied to the wheel brake 10; a pump 70 ejecting the oil stored in the low pressure accumulator 40; a high pressure accumulator 80 in which the oil ejected from the pump 70 is temporarily stored; an electronic control unit (ECU) 110 controlling the NO solenoid check valve 50, the NC solenoid valve 60, and the pump 70; a traction valve 30 installed between the master cylinder, the wheel brake 10, and the high pressure accumulator 80, the traction valve 30 including a check valve 31 that is opened only toward the wheel brake 10 and the high pressure accumulator 80 from the master cylinder 20 and an NC solenoid valve 32 that is closed in a normal state OFF in which power is not applied and is opened in a state ON in which power is applied; a pressure sensor 85 installed in the high pressure accumulator 80 and generating a pressure signal by an oil pressure generated in the high pressure accumulator 80; and a shuttle valve 90 installed between the master cylinder 20 and the traction valve 30 and between the low pressure accumulator 40 and the pump 70, the shuttle valve 90 including a check valve 91 that is opened only toward the master cylinder 20 from the low pressure accumulator 40 and an NC solenoid valve 92 that is closed in a normal state OFF in which power is not applied and is opened in a state ON in which power is applied.

According to another aspect of the present invention, there is provided a method of controlling the brake control system of any one of claims 1 through 3, the method including a driving mode after temporary stoppage during driving (M1) in which, when the vehicle stops when the driver steps on the brake pedal 21 and a brake force is generated, through a brake signal generated in the brake sensor 103, the ECU 110 applies power (ON) to the traction valve 30 and opens a flow path between the master cylinder 20 and the wheel brake 10 so that a brake operation is performed, and, when the driver steps off the brake pedal 21 so as to drive again, the brake oil pressure applied to the wheel brake 10 is completely recovered to the master cylinder 20, the brake state of the wheel brake 10 is released.

### BRIEF DESCRIPTION OF THE DRAWINGS

FIG. 1 is a hydraulic distribution diagram of a vehicle in which a brake control system according to an embodiment of the present invention is employed.

FIG. 2 illustrates the brake control system employed in FIG. 1.

FIG. 3 illustrates sensors and an electronic control unit (ECU) employed in FIG.

### BEST MODE FOR CARRYING OUT THE INVENTION

Hereinafter, a brake control system for a vehicle according to the present invention and a control method thereof will be described in detail with reference to the accompanying drawings.

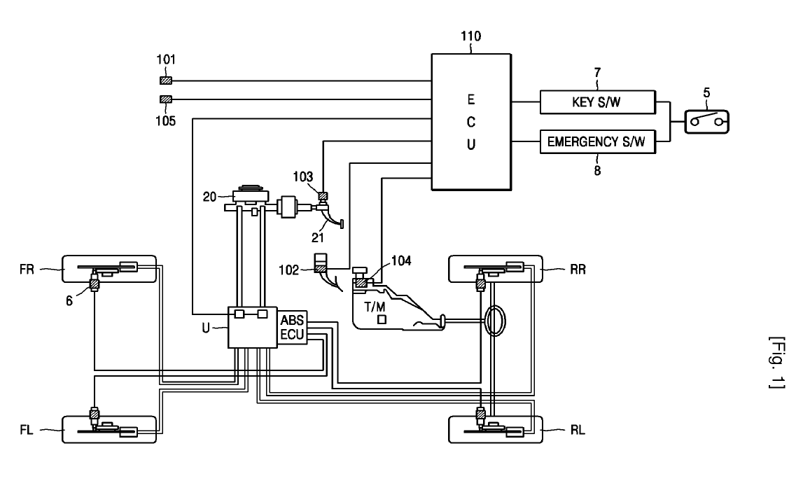

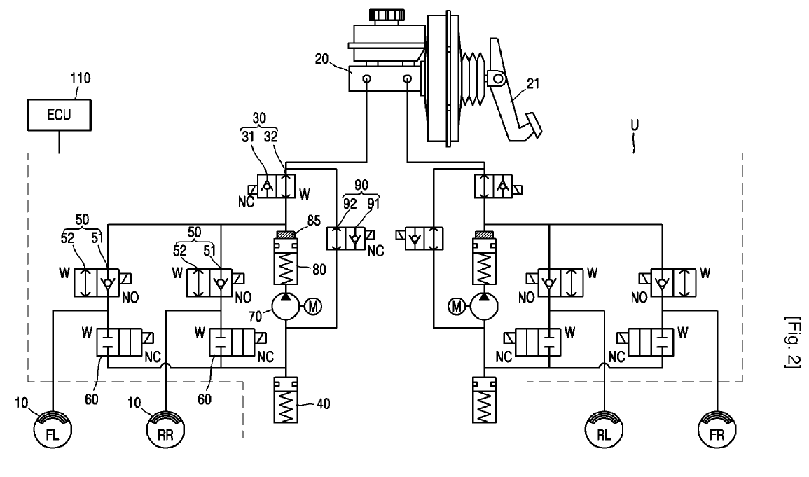

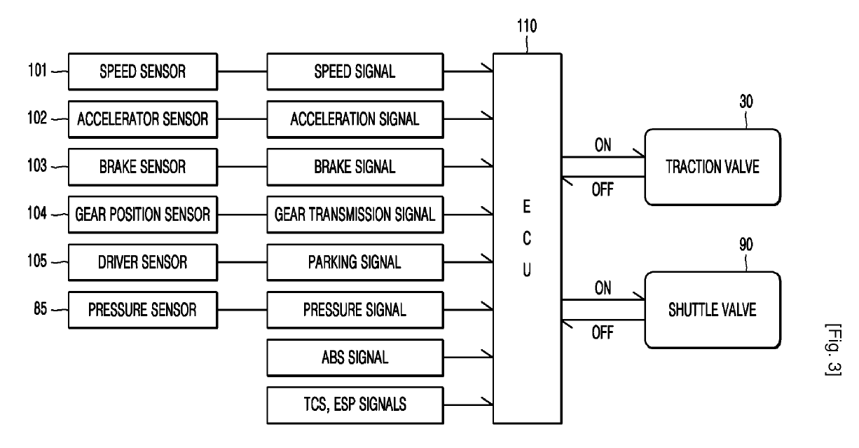

FIG. 1 is a hydraulic distribution diagram of a vehicle in which a brake control system according to an embodiment of the present invention is employed, FIG. 2 illustrates the brake control system employed in FIG. 1, and FIG. 3 illustrates sensors and an electronic control unit (ECU) employed in FIG. 2.

As illustrated in FIGS. 1, 2, and 3, the brake control system includes: a wheel brake 10 for braking four wheels FL, RR, FR, and RL, respectively; a master cylinder 20 for generating a brake oil pressure by forcibly transmitting oil according to the operation of a brake pedal 21; a composite control hydraulic unit U installed between the wheel brake 10 and the master cylinder 20; and an electronic control unit (ECU) 110 for controlling the composite control hydraulic unit U by collectively determining driver s driving will and brake release will. The brake control system is operated by a separate brake system switch 5.

The brake system switch 5 is an ON/OFF selection mode switch and allows the entire operation of the brake control system to be automatically controlled according to a command of the ECU 110 in an ON mode. However, in an OFF mode, a brake can be operated in the same manner as the manner of a general vehicle in which the brake control system of the present invention is not employed. The brake system switch 5 is installed as a unitary body with a 2 shift key switch 7 for allowing the vehicle to start or is installed on a dashboard.

Alternatively, the brake system switch 5 may also be connected to an emergency switch that is directly connected to a battery (not shown). In this case, even though a problem occurs in the entire control system of the vehicle, the emergency switch 8 is operated so that only the brake control system can be controlled and more safe car driving can be made.

The composite control hydraulic unit U includes: a traction valve 30 for controlling the amount and flow of oil forcibly transmitted from the master cylinder 20 to control a brake oil pressure caused by the oil; a low pressure accumulator 40 in which the oil flowed out from the wheel brake 10 is temporarily stored; a Normal Open (NO) solenoid check valve 50 installed between the wheel brake 10 and the traction valve 30 and controlling the amount and flow of the oil transmitted to the wheel brake 10 to control a brake oil pressure applied to the wheel brake 10; a Normal Close (NC) solenoid valve 60 installed between the wheel brake 10 and the low pressure accumulator 40 and controlling the amount and flow of the oil transmitted to the low pressure accumulator 40 from the wheel brake 10 to control a brake oil pressure applied to the wheel brake 10; a pump 70 for ejecting the oil stored in the low pressure accumulator 40; a high pressure accumulator 80 in which the oil ejected from the pump 70 is temporarily stored and which is connected to the traction valve 30; a pressure sensor 85 installed in the high pressure accumulator 80 and generating a pressure signal by an oil pressure generated in the high pressure accumulator 80; a shuttle valve 90 installed between the master cylinder 20 and the traction valve 30 and between the low pressure accumulator 40 and the pump 70; a speed sensor 101 for generating a speed (acceleration or deceleration) signal of a vehicle when a driver drives the vehicle; an accelerator sensor 102 for generating a corresponding signal when the driver steps on an accelerator; a brake sensor 103 for generating a corresponding signal when the driver steps on the brake pedal 21; a gear position sensor 104 for generating a corresponding signal when the driver shifts a transmission (TM) gear; and a driver sensor 105 installed at a driver seat and generating a driver sensing signal when the driver gets off the vehicle.

The wheel brake 10 includes a wheel disc fixed on a wheel, a pad for generating friction with the wheel disc, a wheel cylinder for closely adhering the pad to the wheel disc, and a wheel speed sensor 6 for sensing the speed of the wheel when the wheel is rotated. The wheel brake 10 is a general technology and thus, a further detailed description thereof will be omitted.

The traction valve 30 includes a check valve 31 and an NC solenoid valve 32. The check valve 31 is a one-direction valve that is opened only toward the wheel brake 10 and the high pressure accumulator 80 from the master cylinder 20. The NC solenoid valve 32 is closed in a normal state OFF in which power is not applied and is opened in a state ON in which power is applied, thereby opening the master cylinder 20, the wheel brake 10, and the high pressure accumulator 80 in both directions. In detail, the traction valve 30 includes the check valve 31 and the NC solenoid valve 32 so that the oil ejected from the master cylinder 20 in the normal state OFF in which power is not applied, can flow only into the wheel brake 10 and the high pressure accumulator 80 and therefore, a brake oil pressure is generated in the wheel brake 10 and the NC solenoid valve 32 is opened in the state ON in which power is applied so that the oil can freely flow between the master cylinder 20, the wheel brake 10, and the high pressure accumulator 80 and the brake oil pressure can be generated in both directions.

The NO solenoid check valve 50 includes a check valve 51 and an NO solenoid valve 52. The check valve 51 is a one-direction valve that is opened only toward the traction valve 30 from the wheel brake 10. The NO solenoid valve 52 is opened in a normal state OFF in which power is not applied and opens a flow path between the traction valve 30 and the wheel brake 10 in both directions and is closed in a state ON in which power is applied, thereby closing the flow path between traction valve 30 and the wheel brake 10. In detail, the NO solenoid check valve 50 includes the check valve 51 and the NO solenoid valve 52 so that the oil can freely flow between the traction valve 30 and the wheel brake 10 in the normal state OFF in which power is not applied and the oil pressure can be generated in both directions but in the state ON in which power is applied, the oil can flow only into the traction valve 30 and the brake oil pressure is not generated in the wheel brake 10.

The NC solenoid valve 60 closes the flow path between the wheel brake 10 and the low pressure accumulator 40 in the normal state OFF in which power is not applied, so that the oil does not flow into the flow path between the wheel brake 10 and the low pressure accumulator 40. In the state ON in which power is applied, the NC solenoid valve 60 opens the flow path between the wheel brake 10 and the low pressure accumulator 40 so that the oil can freely flow in both directions.

The pump 70 allows the oil stored in the low pressure accumulator 40 to be flowed into the high pressure accumulator 80.

The high pressure accumulator 80 is a kind of damping chamber, compensates for a volume change of the oil stored according to temperature characteristics and keeps a proper pressure during parking.

The pressure sensor 85 generates a corresponding pressure signal by the oil pressure caused by the oil stored in the high pressure accumulator 80. The pressure signal generated in the pressure sensor 85 is used to operate an ABS mode, a TCS mode or an ESP mode or to determine whether the vehicle is rapidly braked according to speed of the state where the driver steps on the brake pedal and the degree of a pedal effort.

The shuttle valve 90 includes a check valve 91 and an NC solenoid valve 92. The check valve 91 is a one-direction valve that is opened only toward the master cylinder 20 from the low pressure accumulator 40. The NC solenoid valve 92 is closed in a normal state OFF in which power is not applied and is opened in a state ON in which power is applied, thereby opening a flow path between the low pressure accumulator 40 and the master cylinder 20 in both directions. In detail, the shuttle valve 90 includes the check valve 91 and the NC solenoid valve 92 so that the oil of the low pressure accumulator 40 can flow only into the master cylinder 20 and a brake oil pressure is generated only in the mater cylinder 20 in the normal state OFF in which power is not applied, and in the state ON where power is applied, the shuttle valve 90 allows the oil to be freely flowed into the flow path between the low pressure accumulator 40 and the master cylinder 20 so that a bidirectional brake oil pressure is generated.

The speed sensor 101 generates a speed signal corresponding to acceleration or deceleration of the vehicle when the vehicle is driven. The accelerator sensor 102 generates a corresponding acceleration signal when the driver steps on the accelerator. The brake sensor 103 generates a corresponding brake signal when the driver steps on the brake pedal 21. The gear position sensor 104 generates a corresponding gear transmission signal when the driver shifts the TM gear.

The ECU 110 controls the composite control hydraulic unit U, more specifically, the traction valve 30, the NO solenoid check valve 50, the NC solenoid valve 60, the pump 70, and the shuttle valve 90 by collectively determining driver s driving will and brake release will. The ECU 110 senses whether the vehicle is in a driven/stopped state to automatically control brake maintenance and brake release and to properly change a current mode into an ABS mode, a TCS mode, or an ESP mode.

The operation of the brake control system for a vehicle will now be described.

The brake control system operates when the brake system switch 5 is in an ON mode, and when the brake system switch 5 is in an OFF mode, the traction valve 30 is turned on when the driver steps on the brake pedal 21 so that the same brake operation as that of a vehicle in which the brake control system of the present invention is not employed can be performed.

(1) Driving Mode (M1) after Temporary Stoppage During Driving

When the driver steps off the brake pedal 21 so as to start driving after temporary stoppage during driving, a brake state is automatically released and the vehicle must move. In detail, when the vehicle stops when the driver steps on the brake pedal 21 and a brake force is generated, the brake sensor 103 generates a brake signal, transmits the brake signal to the ECU 110, and the speed sensor 101 generates a speed signal. In this case, the ECU 110 determines that the driver has a brake will through the brake signal, applies power (ON) to the traction valve 30 and opens a flow path between the master cylinder 20 and the wheel brake 10 in both directions. As a result, the brake oil pressure of the master cylinder 20 is transmitted to the wheel brake 10 and a brake operation is performed. Subsequently, when the driver steps off the brake pedal 21 so as to drive again, the brake oil pressure applied to the wheel brake 10 is completely recovered to the master cylinder 20, the brake state of the wheel brake 10 is released and the vehicle moves. Once the vehicle moves, the brake sensor 103 does not generate the brake signal and the ECU 110 determines that the driver has a driving will and cuts off the power (OFF) applied to the traction valve 30.

(2) Stoppage Mode During Driving (M2)

When the driver steps on the brake pedal 21 so as to stop during driving, the brake sensor 103 generates a brake signal and the speed sensor 101 generates a speed (deceleration) signal and transmits the speed signal to the ECU 110. Then, the ECU 110 determines that the driver has a brake will through the brake signal and the speed signal and applies power (ON) to the traction valve 30. As such, the brake oil pressure generated in the master cylinder 20 is transmitted to the wheel brake 10 via the traction valve 30 and the NO solenoid check valve 50 and the vehicle stops. When the vehicle stops, the speed signal is not generated in the speed sensor 101 and then, the ECU 110 cuts off the power (OFF) applied to the traction valve 30. Then, the traction valve 30 is closed so that the brake oil pressure applied to the wheel brake 10 is not transmitted to the master cylinder 20 and the wheel brake 10 is kept in the braked state.

(3) Gear Transmission Start Mode after Stoppage (M3)

When the driver sets the vehicle into gear and steps on an accelerator pedal so as to restart, each of the gear position sensor 104 and the accelerator sensor 102 generates a gear transmission signal and an acceleration signal and transmits them to the ECU 110. Then, the ECU 110 determines that the driver has a re-driving will through the signals, applies power (ON) to the traction valve 30 and opens a flow path between the master cylinder 20 and the wheel brake 10 in both directions. Then, the brake oil pressure applied to the wheel brake 10 is transmitted to the master cylinder 20 and the brake state is released. Subsequently, when the vehicle moves and speed is generated, the speed sensor 101 generates a speed (acceleration) signal and transmits the speed (acceleration) signal to the ECU 110, and the ECU 110 cuts off the power (OFF) applied to the traction valve 30 again.

(4) Parking Mode (M4)

When the driver wants to park, a maximum brake oil pressure must be applied to the wheel brake 10. In detail, when the driver turns off the key switch 7 so as to park and the driver gets off the vehicle, the driver sensor 105 installed separately at the driver seat generates a parking signal and transmits the parking signal to the ECU 110. Then, the ECU 110 determines that the driver gets off the vehicle, applies power to the shuttle valve 90 and drives the pump 70 in the state OFF where power is not applied to the traction valve 30. Then, the pump 70 pumps oil stored in the master cylinder 20, the low pressure accumulator 40, and the high pressure accumulator 80 strongly and allows the oil to be transmitted to the wheel brake 10 via the shuttle valve 90, the high pressure accumulator 80, and the NO solenoid check valve 50, sequentially, so that a strong brake oil pressure can be applied to the wheel brake 10.

Subsequently, when an output oil pressure generated in the high pressure accumulator 80 by the pump 70 exceeds a predetermined pressure, the pressure sensor 85 senses the output oil pressure, generates a corresponding oil pressure signal and transmits the oil pressure signal to the ECU 110. Then, the ECU 110 stops the activation of the pump 70, allows the brake oil pressure generated by pumping not to be applied to the wheel brake 10 and cuts off the power (OFF) of the shuttle valve 90. In detail, through the above-described operations, when the driver parks, the vehicle is kept in the state where the maximum brake oil pressure is applied to the wheel brake 10.

(5) ABS Operating Mode (M5)

A signal generated when an Anti-Lock Brake System (ABS) operates in the vehicle is transmitted to the ECU 110. Then, the ECU 110 cuts off the power (OFF) applied to the traction valve 30 and closes a flow path between the wheel brake 10 and the master cylinder 20. As such, when the ABS operates, shock generated in the wheel brake 10 by a brake operation performed several tens of times is not transmitted to the master cylinder 20 so that noise can be prevented together with Kick Back transmitted to the brake pedal 21.

(6) Rapid Brake Mode (M6)

In the state where the driver must step on the brake pedal 21 rapidly, the brake sensor 103 and the speed sensor 101 generate a brake signal and a rapid deceleration signal and transmit the signals to the ECU 110. In the rapid brake state, pressure is suddenly applied to the high pressure accumulator 80 and if the pressure exceeds a pre-determined value, the pressure sensor 85 generates a pressure signal and transmits the pressure signal to the ECU 110. Then, the ECU 110 determines that the driver brakes rapidly through the brake signal, the rapid deceleration signal, and the pressure signal and cuts off the power (OFF) applied to the traction valve 30. Then, the brake oil pressure of the master cylinder 20 is transmitted only to the wheel brake 10 in one direction and the brake oil pressure is cut off in an opposite direction. As a result, a strong brake oil pressure may be applied to the wheel brake 10 only by the weak pressure of the brake pedal 21.

(7) TCS/ESP Operating Mode (M7)

A Traction Control System (TCS) or an Electronic Stability Program (ESP) signal generated when the TCS or ESP operates is transmitted to the ECU 110. Then, the ECU 110 applies power (ON) to the shuttle valve 90 and opens the shuttle valve 90 in both directions so that the brake oil pressure can be transmitted in both directions. Meanwhile, in the state OFF where power is not applied to the traction valve 30, the ECU 110 operates the pump 70. Then, the brake oil pressure generated by the master cylinder 20 and the brake oil pressure generated by pumping the pump 70 are transmitted to the wheel brake 10 via the shuttle valve 90, the high pressure accumulator 80, and the NO solenoid check valve 50, sequentially.

(8) TCS/ESP Non-Operating Mode (M8)

When the driver steps on the brake pedal 21 in a general driving state where the TCS or ESP does not operate, the speed signal generated in the speed sensor 101 and the brake signal generated in the brake signal 103 are transmitted to the ECU 110. Then, the ECU 110 applies power (ON) to the traction valve 30 and opens the traction valve 30 in both directions. When the driver steps on the brake pedal 21 so that a locking phenomenon of wheels does not occur in this state, the brake oil pressure generated in the master cylinder 20 is transmitted to the wheel brake 10 of each wheel via the traction valve 30 and the NO solenoid check valve 50, sequentially, so that the brake operation is performed. When the driver steps off the brake pedal 21 without the need of brake, the oil transmitted to the wheel brake 10 is returned to the master cylinder 20 and pressure is reduced. Subsequently, the ECU 110 cuts off the power (OFF) applied to the traction valve 30 so that the traction valve 30 prevents the oil returned to the master cylinder 20 from being transmitted to the wheel brake 10 again.

(9) Excessive Brake Oil Pressure Control Mode (M9)

When an excessive oil pressure greater than a predetermined value is generated between the traction valve 30 and the wheel brake 10 in the state where the speed signal is generated in the speed sensor 101 during driving and the driver does not step on the brake pedal 21, the pressure sensor 85 senses the oil pressure, generates a corresponding pressure signal and transmits the pressure signal to the ECU 110. Then, the ECU 110 applies power (ON) to the traction valve 30 and allows the bidirectional flow of the oil so that the excessive brake oil pressure generated between the traction valve 30 and the wheel brake 10 is transmitted to the master cylinder 20.

(10) Excessive Brake Oil Pressure Control Mode (M10)

There is another method of controlling an excessive brake oil pressure greater than a predetermined value between the traction valve 30 and the wheel brake 10 during driving. In detail, in the state where the speed signal is generated in the speed sensor 101 during driving and the driver does not step on the brake pedal 21, the ECU 110 applies power (ON) to the traction valve 30 during a predetermined period (for example, 1 second per 120 second) and allows the bidirectional flow of the oil. As a result, the excessive brake oil pressure generated between the traction valve 30 and the wheel brake 10 is transmitted to the master cylinder 20.

In this way, through the excessive brake oil pressure control modes (M9) and (M10), even when the driver does not step on the brake pedal 21 during driving, a proper pressure between the master cylinder 20 and the wheel brake 10 can be kept such that friction between the wheel disc of the wheel brake and the pad can be reduced.

While the present invention has been particularly shown and described with reference to exemplary embodiments thereof, it will be understood by those skilled in the art that various changes in form and details may be made therein without departing from the spirit and scope of the invention as defined by the following claims.

### INDUSTRIAL APPLICABILITY

As described above, in the brake control system for a vehicle according to the present invention, the composite control hydraulic unit for connecting various kinds of sensors 101, 102, 103, 104, and 105, the traction valve, the shuttle valve, the NO solenoid check valve, the NC solenoid valve, and the ECU is employed such that driver s driving and brake will can be correctly reflected and a complete brake operation can be performed during driving or stoppage.

In addition, the ABS, TCS, and ESP operations can be completely performed without a driver's additional operation when the driver starts driving after stoppage or when the driver stops during driving such that a more safe brake operation can be performed.

In addition, whether the vehicle is in a driven/stopped state or not is sensed such that a temporary or continuous brake operation of the brake control system can be automatically performed. As such, when the driver starts on a sloped road, the driver does not feel the vehicle pushed, it is effective to prevent a rapid start accident of the vehicle, there is no need for continuously stepping on the pedal during signal waiting and parking/stoppage and conveniences are provided to the driver.

And, the side brake does not need to be employed such that consumable components for constituting the side brake do not need to be provided or an action for operating the side brake does not need to be taken.

1. A brake control system for a vehicle, the brake control system comprising:
a wheel brake 10 braking four wheels FL, RR, FR, and RL of the vehicle, respectively;
a master cylinder 20 generating a brake oil pressure by forcibly transmitting oil according to the operation of a brake pedal 21;
a low pressure accumulator 40 in which the oil flowed out from the wheel brake 10 is temporarily stored;
a Normal Open (NO) solenoid check valve 50 controlling the amount and flow of the oil transmitted to the wheel brake 10 to control a brake oil pressure applied to the wheel brake 10;
a Normal Close (NC) solenoid valve 60 installed between the wheel brake 10 and the low pressure accumulator 40 and controlling the amount and flow of the oil transmitted to the low pressure accumulator 40 from the wheel brake 10 to control a brake oil pressure applied to the wheel brake 10;
a pump 70 ejecting the oil stored in the low pressure accumulator 40;
a high pressure accumulator 80 in which the oil ejected from the pump 70 is temporarily stored;
an electronic control unit (ECU) 110 controlling the NO solenoid check valve 50, the NC solenoid valve 60, and the pump 70;
a traction valve 30 installed between the master cylinder 20, the wheel brake 10, and the high pressure accumulator 80, the traction valve 30 including a check valve 31 that is opened only toward the wheel brake 10 and the high pressure accumulator 80 from the master cylinder 20 and an NC solenoid valve 32 that is closed in a normal state OFF in which power is not applied and is opened in a state ON in which power is applied;
a pressure sensor 85 installed in the high pressure accumulator 80 and generating a pressure signal by an oil pressure generated in the high pressure accumulator 80; and
a shuttle valve 90 installed between the master cylinder 20 and the traction valve 30 and between the low pressure accumulator 40 and the pump 70, the shuttle valve 90 including a check valve 91 that is opened only toward the master cylinder 20 from the low pressure accumulator 40 and an NC solenoid valve 92 that is closed in a normal state OFF in which power is not applied and is opened in a state ON in which power is applied.

2. The brake control system of claim 1, further comprising:
a speed sensor 101 generating a speed (acceleration or deceleration) signal of the vehicle when a driver drives the vehicle;
an accelerator sensor 102 generating a corresponding signal when the driver steps on an accelerator;
a brake sensor 103 generating a corresponding signal when the driver steps on the brake pedal 21; and
a gear position sensor 104 generating a corresponding signal when the driver shifts a transmission (TM) gear.

3. The brake control system of claim 1, further comprising a driver sensor 105 installed at a driver seat and generating a driver sensing signal when the driver gets off the vehicle.

4. The method of controlling the brake control system of claim 1, the method comprising a driving mode after temporary stoppage during driving (M1) in which, when the vehicle stops when the driver steps on the brake pedal 21 and a brake force is generated, through a brake signal generated in the brake sensor 103, the ECU 110 applies power (ON) to the traction valve 30 and opens a flow path between the master cylinder 20 and the wheel brake 10 so that a brake operation is performed, and, when the driver steps off the brake pedal 21 so as to drive again, the brake oil pressure applied to the wheel brake 10 is completely recovered to the master cylinder 20, the brake state of the wheel brake 10 is released.

5. The method of claim 4, further comprising a stoppage mode during driving (M2) in which, when the driver steps on the brake pedal 21 so as to stop during driving, through a brake signal generated in the brake sensor 103 and a speed (deceleration) signal generated in the speed sensor 101, the ECU 110 applies power (ON) to the traction valve 30 so that the brake oil pressure generated in the master cylinder 20 is transmitted to the wheel brake 10 via the traction valve 30 and the NO solenoid check valve 50, and when the vehicle stops, the ECU 110 cuts off the power (OFF) applied to the traction valve 30 so that the brake oil pressure applied to the wheel brake 10 is not transmitted to the master cylinder 20.

6. The method of claim 4, further comprising a gear transmission start mode after stoppage (M3) in which, when the driver sets the vehicle into gear and steps on an accelerator pedal so as to restart, through a gear transmission signal and an acceleration signal generated in the gear position sensor 104 and the accelerator sensor 102, respectively, the ECU 110 applies power (ON) to the traction valve 30 and opens a flow path between the master cylinder 20 and the wheel brake 10 in both directions so that the brake oil pressure applied to the wheel brake 10 is transmitted to the master cylinder 20 and the brake state is released.

7. The method of claim 4, further comprising a parking mode (M4) in which, when the driver turns off the key switch 7 so as to park and the driver gets off the vehicle, through a parking signal generated in the driver sensor 105, the ECU 110 applies power (ON) to the shuttle valve 90 and drives the pump 70 in the state OFF where power is not applied to the traction valve 30 so that the pump 70 pumps oil stored in the master cylinder 20, the low pressure accumulator 40, and the high pressure accumulator 80 strongly and allows the oil to be transmitted to the wheel brake 10 via the shuttle valve 90, the high pressure accumulator 80, and the NO solenoid check valve 50, sequentially, so that a strong brake oil pressure can be applied to the wheel brake 10.

8. The method of claim 7, further comprising, when an output oil pressure generated in the high pressure accumulator 80 by the pump 70 exceeds a predetermined pressure, through an oil pressure signal generated in the pressure sensor 85, stopping the activation of the pump 70 and allowing the brake oil pressure generated by pumping not to be applied to the wheel brake 10 using the ECU 110.

9. The method of claim 4, further comprising an Anti-Lock Brake System (ABS) operating mode (M5) in which, through an ABS signal generated when an Anti-Lock Brake System (ABS) operates in the vehicle, the ECU 110 cuts off the power (OFF) applied to the traction valve 30 and closes a flow path between the wheel brake 10 and the master cylinder 20 so that shock generated in the wheel brake 10 by a brake operation performed several tens of times is not transmitted to the master cylinder 20.

10. The method of claim 4, further comprising a rapid brake mode (M6) in which, when the driver must step on the brake pedal 21 rapidly so as to rapidly brake the vehicle, through a brake signal and a rapid deceleration signal generated in the brake sensor 104 and the speed sensor 101, respectively, the ECU 110 cuts off the power (OFF) applied to the traction valve 30 so that the brake oil pressure of the master cylinder 20 is transmitted only to the wheel brake 10 in one direction and the brake oil pressure is cut off in an opposite direction.

11. The method of claim 4, further comprising a Traction Control System (TCS) or an Electronic Stability Program (ESP) operating mode (M7) in which, when the TCS or ESP operates in the vehicle, through a generated TCS or ESP signal, the ECU 110 applies power (ON) to the shuttle valve 90 and opens the shuttle valve 90 in both directions so that the brake oil pressure can be transmitted in both directions, and in the state OFF where power is not applied to the traction valve 30, the ECU 110 operates the pump 70 to generate a brake pressure by pumping so that the brake oil pressure generated by the master cylinder 20 and the brake oil pressure generated by pumping the pump 70 are transmitted to the wheel brake 10 via the shuttle valve 90, the high pressure accumulator 80, and the NO solenoid check valve 50, sequentially.

12. The method of claim 4, further comprising a TCS/ESP non-operating mode (M8) in which, when the driver steps on the brake pedal 21 in a general driving state where the TCS or ESP does not operate, through the speed signal generated in the speed sensor 101 and the brake signal generated in the brake signal 103, the ECU 110 applies power (ON) to the traction valve 30 and opens the traction valve 30 in both directions, and when the driver steps on the brake pedal 21 so that a locking phenomenon of wheels does not occur in this state, the brake oil pressure generated in the master cylinder 20 is transmitted to the wheel brake 10 of each wheel via the traction valve 30 and the NO solenoid check valve 50, sequentially, so that the brake operation is performed.

13. The method of claim 4, further comprising an excessive brake oil pressure control mode (M9) in which, when an excessive oil pressure greater than a predetermined value is generated between the traction valve 30 and the wheel brake 10 in the state where the speed signal is generated in the speed sensor 101 during driving and the driver does not step on the brake pedal 21, through a pressure signal generated in the pressure sensor 85, the ECU 110 applies power (ON) to the traction valve 30 and allows the bidirectional flow of the oil so that the excessive brake oil pressure generated between the traction valve 30 and the wheel brake 10 is transmitted to the master cylinder 20.

14. The method of claim 4, further comprising an excessive brake oil pressure control mode (M10) in which, when an excessive oil pressure greater than a predetermined value is generated between the traction valve 30 and the wheel brake 10 in the state where the speed signal is generated in the speed sensor 101 during driving and the driver does not step on the brake pedal 21, through a pressure signal generated in the pressure sensor 85, the ECU 110 applies power (ON) to the traction valve 30 during a predetermined period and allows the bidirectional flow of the oil so that the excessive brake oil pressure generated between the traction valve 30 and the wheel brake 10 is transmitted to the master cylinder 20.

15. The brake control system of claim 2, further comprising a driver sensor 105 installed at a driver seat and generating a driver sensing signal when the driver gets off the vehicle.

16. The method of controlling the brake control system of claim 2, the method comprising a driving mode after temporary stoppage during driving (M1) in which, when the vehicle stops when the driver steps on the brake pedal 21 and a brake force is generated, through a brake signal generated in the brake sensor 103, the ECU 110 applies power (ON) to the traction valve 30 and opens a flow path between the master cylinder 20 and the wheel brake 10 so that a brake operation is performed, and, when the driver steps off the brake pedal 21 so as to drive again, the brake oil pressure applied to the wheel brake 10 is completely recovered to the master cylinder 20, the brake state of the wheel brake 10 is released.

17. The method of controlling the brake control system of claim 3, the method comprising a driving mode after temporary stoppage during driving (M1) in which, when the vehicle stops when the driver steps on the brake pedal 21 and a brake force is generated, through a brake signal generated in the brake sensor 103, the ECU 110 applies power (ON) to the traction valve 30 and opens a flow path between the master cylinder 20 and the wheel brake 10 so that a brake operation is performed, and, when the driver steps off the brake pedal 21 so as to drive again, the brake oil pressure applied to the wheel brake 10 is completely recovered to the master cylinder 20, the brake state of the wheel brake 10 is released.
